(19) United States
(12) Patent Application Publication
(10) Pub. No.: US 2026/0370313 A1
(43) Pub. Date: Nov. 19, 2026

(54) Ray-Tracing Channel Modeling Method for Low-Earth-Orbit Satellite Communications

(71) Applicant: NANJING JIEXI TECHNOLOGY CO., LTD., Nanjing (CN)

(72) Inventors: Chengxiang WANG, Nanjing (CN); Kaiyuan ZHANG, Nanjing (CN); Songjiang YANG, Nanjing (CN); Yinghua WANG, Nanjing (CN); Baohua CAO, Nanjing (CN); Xiaocong WANG, Nanjing (CN)

(21) Appl. No.: 19/704,551

(22) Filed: Jun. 11, 2026

Related U.S. Application Data
(63) Continuation of application No. PCT/CN2023/141952, filed on Dec. 26, 2023.

(30) Foreign Application Priority Data
Dec. 21, 2023 (CN) 202311763522.2

(51) Int. Cl. H04B 7/185; H04B 17/391

(52) U.S. Cl. CPC H04B 7/18513; H04B 17/3911; H04B 17/3912

(57) ABSTRACT

The present invention relates to wireless communications and provides a ray tracing-based channel modeling method for low Earth orbit satellite communications. The method improves channel modeling accuracy by accounting for channel characteristics that are not fully considered in conventional low Earth orbit satellite channel modeling. The method includes generating atmospheric and near-ground environment parameters, including an ionospheric scintillation parameter, a rainfall parameter, and a near-ground environment parameter; modeling large-scale fading and near-ground small-scale fading, including ionospheric scintillation, rain attenuation, and ray tracing-based multipath effects; and calculating received-power parameters, including power delay profiles for different near-ground scenarios and total received powers under different satellite elevation angles and rainfall rates. By considering ionospheric scintillation, rainfall, and multipath effects, the method provides an accurate reference for low Earth orbit satellite channel analysis and simulation.

### TECHNICAL FIELD

The present disclosure relates to the technical field of wireless communications, and in particular to a ray tracing-based channel modeling method directed to low Earth orbit (LEO) satellite communication.

### BACKGROUND

After completion of a first full set of standards for fifth-generation (5G) mobile communication systems, initial commercial deployment of 5G wireless networks commenced in 2019. However, the revolutionary vision of 5G has not been fully realized. Current 5G wireless networks still have many deficiencies for Internet of Everything (IoE) systems supporting a huge number of device connections by users. Sixth-generation (6G) wireless networks are developed to not only achieve higher transmission rates, but also to further expand boundaries and scope of IoE on the basis of 5G wireless network services. Satellite communication networks are a key focus for 6G wireless network research. Compared with terrestrial wireless communication systems, satellite communication systems have advantages such as wide coverage and large communication capacity. Compared with high-orbit and medium-orbit satellite communication systems, low Earth orbit satellite communication systems have characteristics of low latency, low power consumption, low propagation loss, and flexible networking. In recent years, new-generation Internet constellation projects have been gradually implemented, with a transition from low-frequency bands such as L (1-2 GHz) and S (2-4 GHz) to high-frequency bands such as Ku (12-18 GHz) and Ka (26-40 GHz). To achieve reliable and efficient transmission of low Earth orbit satellite communication information, it is necessary to study propagation characteristics of low Earth orbit satellite communication channels and model same.

Low Earth orbit satellite communication channels are affected by many factors, including atmospheric absorption, rain attenuation, ionospheric scintillation, and Doppler shift, resulting in significant time-variability and difficulty to analyze accurately. Existing methods of low Earth orbit satellite channel modeling include geometry-based stochastic channel modeling and ray tracing channel modeling. Existing models established through the method of geometry-based stochastic channel modeling have high universality, but in view of high-accuracy requirements of current 5G mobile communication systems, the method of ray tracing has higher accuracy than the method of geometry-based stochastic channel modeling. Some scholars have modeled low Earth orbit satellite channels in scenarios of helicopters, urban areas, and satellite solar panels through the method of ray tracing, but few scholars have considered influencing factors such as ionospheric scintillation and rainfall in the atmosphere, and characteristic analysis of multipath effects in urban areas has not been fully studied. In summary, an accurate low Earth orbit satellite channel model is required to meet the demands of 6G wireless communication networks.

### SUMMARY

Invention objective: an objective is to provide a ray tracing-based channel modeling method directed to low Earth orbit satellite communication to solve the above problems existing in the prior art.

The ray tracing-based channel modeling method directed to low Earth orbit satellite communication includes the following steps:
S1, generating low Earth orbit satellite system parameters, where the low Earth orbit satellite system parameters include basic parameters, atmospheric channel environment parameters, and near-ground channel environment parameters;
S2, performing modeling on a large-scale fading channel, including ionospheric scintillation fading modeling and rain attenuation modeling;
S3, performing modeling on a near-ground small-scale fading channel, including ray tracing-based multipath effect modeling;
S4, calculating a large-scale fading loss and multipath received power of a low Earth orbit satellite channel on the basis of steps S1 to S3; and
S5, implementing a low Earth orbit satellite simulation channel model on the basis of step S4, analyzing channel characteristics, and calculating total received power and a power delay profile.

In a further embodiment, the basic parameters include a satellite altitude, an elevation angle, an operating frequency band, and transmit power; and
a satellite-to-near-ground communication link distance L is calculated as follows:

$$L = \sqrt{{R}_{E}^{2} {sin}^{2} θ + {H}^{2} + 2 {R}_{E} H} - {R}_{E} sin θ$$

where θ is a satellite elevation angle, H is a satellite altitude, and R_{E}=6371 km is an Earth radius.

The atmospheric channel environment parameters include an ionospheric scintillation parameter and a rainfall parameter;
the ionospheric scintillation parameter S is configured to describe an intensity of ionospheric scintillation and is calculated as follows:

$$S = {( \frac{〈 {I}^{2} 〉 - {〈 I 〉}^{2}}{{〈 I 〉}^{2}} )}^{\frac{1}{2}}$$

where I represents a signal intensity proportional to a square root of a signal amplitude; <*> denotes an ensemble average of values in parentheses; and
a scintillation index is typically classified into three levels: weak (S<0.3), moderate (0.3<S<0.6), and strong (S>0.6). For weak and moderate levels, a fixed relationship exists between S and f (GHz), and is defined as follows:

S=fⁿ
where f is an operating frequency, and n is a scintillation index factor; and for bands above an S band, the scintillation index factor n from multiple field measurements ranges from −1.6 to −1.9, with an average value of −1.7.

The rainfall parameter includes a rainfall rate Rₚ (mm/h). The rainfall rate Rₚ is a rainfall rate at a system outage probability of p %, and an average rainfall R_{0.001} with a probability exceeding 0.01% is typically used to measure the rainfall in a certain area.

The near-ground channel environment parameters are urban building scenario parameters, including a building outline dimension, a building height, and a building surface reflection coefficient.

The building outline dimension includes building edge point coordinates and a building spacing, which are obtained through actual scenario measurements.

The building height has a significant impact on electromagnetic wave propagation. A line-of-sight path may be blocked by a tall building, and the number of reflected paths may change with changes in building heights around a receiving point. A building height h provided in Recommendation ITU-R P.1410 follows a Rayleigh distribution of a parameter γ, where γ is a typical building height in an urban scenario:

$$P ( h ) = \frac{{e}^{- \frac{{h}^{2}}{2 {γ}^{2}}} h}{{γ}^{2}}$$

The building surface reflection coefficient r depends on a dielectric constant εᵣ of a building surface material, and an included angle α between an incident wave and a dielectric surface satisfies the following relationship:

$$r = \frac{{ε}_{r} sin α - \sqrt{{ε}_{r} - {cos}^{2} α}}{{ε}_{r} sin α + \sqrt{{ε}_{r} - {cos}^{2} α}}$$

In a further embodiment, the step S2 specifically includes:
S201, performing ionospheric scintillation fading modeling, and calculating an ionospheric scintillation loss PL_{fluc} (dB) according to a scintillation index S, with a calculation method as follows:

PL_{fluc}=27.5×S^{1.26}
S202, performing rain attenuation modeling, where the rainfall along a signal propagation path mainly affects a satellite communication system above 3 GHz. First, an equivalent path length L(R_{0.01}, θ) is determined based on a rainfall intensity R_{0.01} and the satellite elevation angle θ, and a calculation method is as follows:

$$L ( {R}_{0.01} , θ ) = {[ 7.41 \times 1 {0}^{- 3} {R}_{0.01}^{0.776} + ( 0.232 - 1.8 \times 1 {0}^{- 4} {R}_{0.01} ) sin θ ]}^{- 1}$$

Secondly, a rain-induced fade PLᵣₐᵢₙ is estimated based on a rain attenuation model provided in ITU-R P.838:

PLᵣₐᵢₙ=K(R_{0.01})^{α}L(R_{0.001},θ)
where parameters K and α are rain attenuation coefficients related to the operating frequency f, the satellite elevation angle θ, and a polarization tilt angle, and are obtainable from ITU-R P.838.

In a further embodiment, the step S3 specifically includes:
S301, generating a near-ground circular equivalent planar array for transmitting. The near-ground circular equivalent planar array for transmitting specifically includes assuming that a low Earth orbit satellite transmitter always points to a ground terminal. When a transmitted signal propagates over a long distance in the atmosphere, signal energy is uniformly distributed on a cross-section perpendicular to a propagation direction, and the signal arrives above urban buildings. According to a plane wave assumption, an electromagnetic wave propagated by a low Earth orbit satellite through an ionosphere above an urban area approximates a circular plane with a radius Rₜ. The radius depends on a satellite altitude. A circle center lies on the line-of-sight path, and a distance from the circle center to a receiving antenna is fixed. A normal vector v of the plane is a vector of the line-of-sight path. The plane uniformly emits a plurality of parallel rays of equal energy along the vector v.
S302, performing ray tracing-based multipath generation. The ray tracing-based multipath generation specifically includes: when rays emitted from the circular equivalent planar array pass through a building surface, a corresponding reflection path is calculated by an image method, and at a receiving end, a sphere with a radius Rᵣ is used for reception determination. The emitted rays undergo single or multiple reflections, some of the rays reach the receiving end and are effectively received, and the rays that effectively reach the receiving end are calculated one by one to obtain a propagation path.

In a further embodiment, the large-scale fading loss of a low Earth orbit satellite channel is calculated as follows:

$$PL = \{ \begin{matrix}{PL}_{fs} + {PL}_{fluc} , f \leq 3 GHz \\ {PL}_{fs} + {PL}_{rain} , f > 3 GHz\end{matrix}$$

where PL_{fluc} represents an ionospheric scintillation loss, PLᵣₐᵢₙ is a rainfall loss, and PL_{fs} is a free-space path loss; and
the free-space path loss PL_{fs} is calculated as follows:

PL_{fs}=32.44+20 log ₁₀L(km)+20 log₁₀f(MHz)
where L (km) represents the satellite-to-near-ground communication link distance; and f (MHz) represents the operating frequency.

The multipath received power Pₘₚ(τᵢ) is calculated as follows:

$${{P}_{mp} ( {τ}_{i} ) = {{P}_{t} [ \frac{λ}{4 π} ]}^{2} \vert \frac{{r}_{i} {e}^{- j Δ {ϕ}_{i}}}{{l}_{i}} \vert}^{2}$$

where τᵢ is a time delay of an i^{th} reflected path relative to the line-of-sight path,lᵢ is a length of an i^{th} path, Pₜ represents transmit power, λ is a signal wavelength, rᵢ is a reflection coefficient, and Δφᵢ=2π(lᵢ−l₁)/λ is a phase difference of the i^{th} path relative to the line-of-sight path. When the line-of-sight path exists,

$${τ}_{i} = \frac{{l}_{i} - {l}_{1}}{c} .$$

Each signal reflection causes a loss of signal energy, and third-order and higher-order reflected signal components are negligible because they are submerged in noise. Therefore, a multipath reflection model includes direct signals, first-order reflected signals, and second-order reflected signals. In the second-order reflected signals, rᵢ is a product of two reflection coefficients.

Root-mean-square (RMS) delay spread is calculated as follows:

$$σ = \sqrt{\overline{{τ}^{2}} - {\overline{τ}}^{2}}$$

where τ̅²̅ is a second-order moment of a power delay profile (PDP). The RMS delay spread reflects a degree of multipath delay dispersion.

Therefore, total multipath received power is calculated as follows:

$${P}_{mp} = 10 {log}_{20} [ {{P}_{t} ( \frac{λ}{4 π} )}^{2} {\vert \frac{1}{{l}_{1}} + {\sum }_{i = 2}^{N} \frac{{r}_{i} {e}^{- j Δ {ϕ}_{i}}}{{l}_{i}} \vert}^{2} ]$$

Total received power Pᵣ(dBm) is calculated as follows:

$${P}_{r} = \{ \begin{matrix}{P}_{mp} - {PL}_{fs} - {PL}_{fluc} , f \leq 3 GHz \\ {P}_{mp} - {PL}_{fs} - {PL}_{rain} , f > 3 GHz\end{matrix}$$

The power delay profile Pᵣ(Ti)(dBm) is calculated as follows:

$${P}_{r} ( {τ}_{i} ) = \{ \begin{matrix}{P}_{mp} ( {τ}_{i} ) - {PL}_{fs} - {PL}_{fluc} , f \leq 3 GHz \\ {P}_{mp ( {τ}_{i} )} - {PL}_{fs} - {PL}_{rain} , f > 3 GHz\end{matrix}$$

where PL_{fs} represents the free-space path loss; PL_{fluc} represents the ionospheric scintillation loss; PLᵣₐᵢₙ represents the rainfall loss; Pₘₚ represents the total multipath received power; lᵢ represents the length of an i^{th} path, Pₜ denotes the transmit power, λ is the signal wavelength, rᵢ is the reflection coefficient, and Δφᵢ=2π(lᵢ−lᵢ)/λ is the phase difference of the i^{th} path relative to the line-of-sight path.

Beneficial effects: Compared with the method of geometry-based stochastic channel modeling, the ray tracing-based channel modeling method directed to low Earth orbit satellite communication provided by the present disclosure features appropriate complexity and higher accuracy. Furthermore, the present disclosure adapts to various specific scenarios by adjusting position and height distributions of ground buildings, having higher universality. Additionally, the present disclosure compares a model in 3GPP TR 38.811 and obtains a similar receiving power trend. Therefore, the present disclosure enables accurate modeling of low Earth orbit satellite-to-ground communication channels in urban environments.

### BRIEF DESCRIPTION OF THE DRAWINGS

FIG. 1 is a schematic flowchart of a ray tracing-based channel modeling method directed to low Earth orbit satellite communication.

FIG. 2 is a schematic diagram of a transmitting/receiving antenna and ray propagation in a near-ground scenario according to an embodiment of the present disclosure.

FIG. 3 is a schematic diagram of a three-dimensional urban model according to an embodiment of the present disclosure.

FIG. 4(a) is a power delay profile diagram of a dense high-rise building scenario.

FIG. 4(b) is a power delay profile diagram of a residential area scenario.

FIG. 5(a) is a power delay profile diagram of a dense high-rise building scenario.

FIG. 5(b) is a power delay profile diagram of a residential area scenario.

FIG. 6 illustrates received power at different rainfall rates calculated according to an embodiment of the present disclosure.

### DETAILED DESCRIPTIONS OF THE EMBODIMENTS

In the following description, many specific details are given to provide a thorough understanding of the present disclosure. However, it will be apparent to those skilled in the art that the present disclosure may be implemented without one or more of these details. In other embodiments, some technical features that are well known in the art have not been described in order to avoid obscuring the present disclosure.

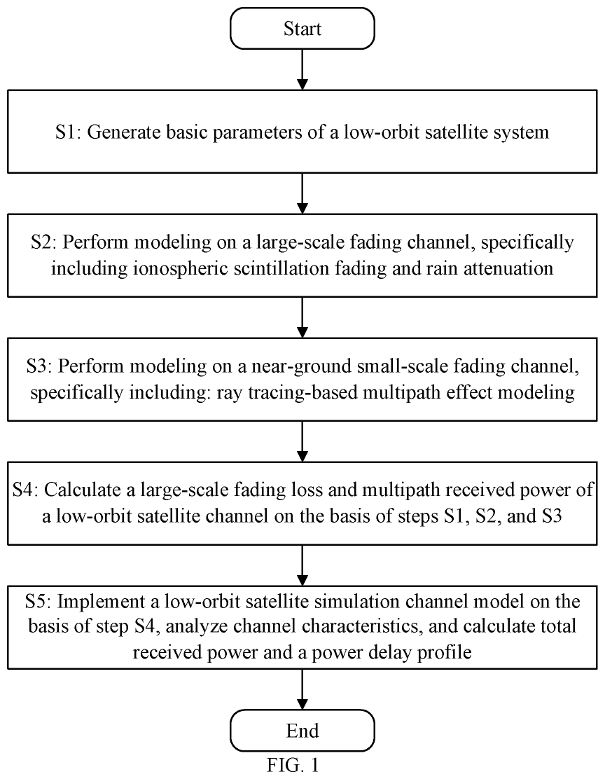

In the present embodiment, a ray tracing-based channel modeling method directed to low Earth orbit satellite communication is detailed, as shown in FIG. 1:
S1, basic parameters of a low Earth orbit satellite system are generated;
S101, a low Earth orbit satellite altitude H is 550 km, operating frequencies f are 2 GHz, 28 GHz, and 40 GHz respectively, transmit power Pₜ is 1000 mW, and an Earth radius R_{E}=6371 km.
S102, a distance L from a satellite to a ground receiver is calculated from a satellite elevation angle θ, the satellite altitude H, and the Earth radius R_{E} as follows:

$$L = \sqrt{{R}_{E}^{2} {sin}^{2} θ + {H}^{2} + 2 {R}_{E} H} - {R}_{E} sin θ$$

S103, the atmospheric channel environment includes an ionospheric scintillation parameter and a rainfall parameter.

An intensity of ionospheric scintillation is typically described by a scintillation index S, and calculated as follows:

$$S = {( \frac{〈 {I}^{2} 〉 - {〈 I 〉}^{2}}{{〈 I 〉}^{2}} )}^{\frac{1}{2}}$$

The scintillation index is typically classified into three levels: weak (S<0.3), moderate (0.3<S<0.6), and strong (S>0.6). For weak and moderate levels, a fixed relationship exists between S and f (GHz):

S=fⁿ
where f is an operating frequency, and n is a scintillation index factor. For bands above an S band, the scintillation index factor n from multiple field measurements has an average value of −1.7.

The rainfall parameter specifically includes a rainfall rate Rₚ (mm/h). The rainfall rate Rₚ is a rainfall rate at a system outage probability of p %, and an average rainfall R_{0.01} with a probability exceeding 0.01% is typically used to measure the rainfall rate in a certain area. The rainfall rate R_{0.01} is set to 0-120 mm/h.
S104, the near-ground channel environment parameters are mainly urban building scenario parameters, including a building outline dimension, a building height, and a building surface reflection coefficient.

The building outline dimension specifically includes building edge point coordinates and a building spacing, which are obtained from actual scenario data.

The building height has a significant impact on electromagnetic wave propagation. A line-of-sight path may be blocked by a tall building, and the number of reflected paths may change with changes in building heights around a receiving point. A building height h provided in Recommendation ITU-R P.1410 follows a Rayleigh distribution of a parameter γ, where γ is a typical building height in an urban scenario:

$$P ( h ) = \frac{{e}^{- \frac{{h}^{2}}{2 {γ}^{2}}} h}{{γ}^{2}}$$

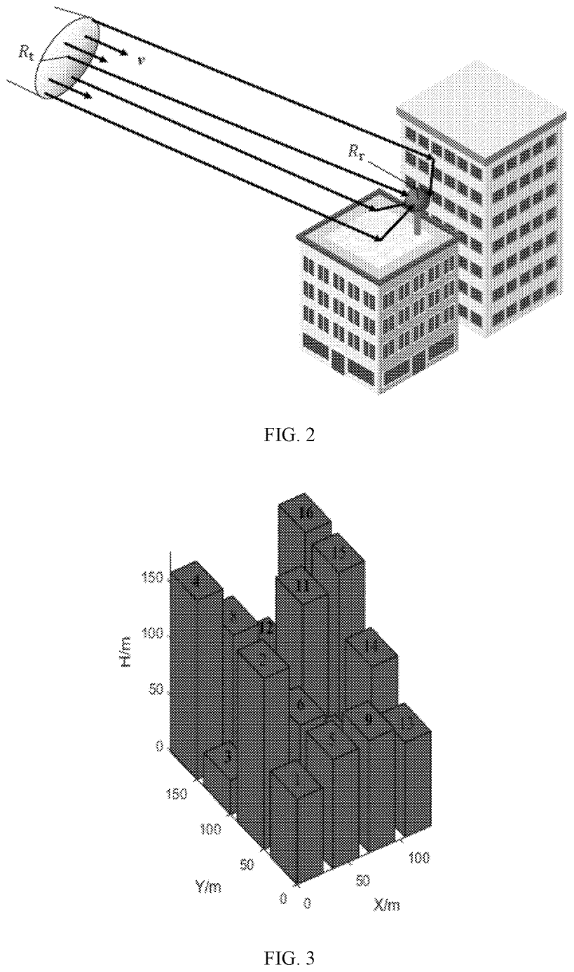

A urban model for simulation is set as a local urban area composed of 16 buildings, the buildings are arranged in a pattern of 4×4, and as shown in FIG. 3, a road with a width d is disposed between every two buildings, and vertical outlines of each building are the same, with a length a along the x-axis and a length b along the y-axis.

A dense high-rise building scenario and a residential area scenario are set for simulation. For the dense high-rise building scenario, a road width d=10 m, the length a=40 m along the x-axis, the length b=25 m along the y-axis, and the parameter γ=100. For the residential area scenario, the road width d=10 m, the length a=30 m along the x-axis, the length b=15 m along the y-axis, and the parameter γ=30.

The building surface reflection coefficient r depends on a dielectric constant εᵣ of a building surface material. In an embodiment, all reflection planes are considered to be made of concrete, with a dielectric constant εᵣ=6.2. An included angle α between an incident wave and a dielectric surface satisfies the following relationship:

$$r = \frac{{ε}_{r} sin α - \sqrt{{ε}_{r} - {cos}^{2} α}}{{ε}_{r} sin α + \sqrt{{ε}_{r} - {cos}^{2} α}}$$

S2, modeling on a large-scale fading channel is performed, specifically including ionospheric scintillation fading and rain attenuation;
S201, an ionospheric scintillation loss PL_{fluc} (dB) satisfies the following relationship:

PL_{fluc}=27.5×S^{1.26}

At an operating frequency of 2 GHz, PL_{fluc}=6 dB, and at an operating frequency above 10 GHz, the ionospheric scintillation loss is negligible.
S202, different rainfalls under clear weather and heavy rain are simulated. First, an equivalent path lengthL(R_{0.01}, θ) is determined based on a rainfall intensity R_{0.01} and the satellite elevation angle θ, and a calculation method is as follows:

L(R_{0.01},θ)=[7.41×10⁻³R_{0.001}^{0.776}+(0.232−1.8×10⁻⁴R_{0.01})sin θ]⁻¹

The rain attenuation is calculated as follows:

PLᵣₐᵢₙ=K(R_{0.01})^{α}L(R_{0.01},θ)

According to ITU-R P.838, at 2 GHz, a rainfall coefficient K is 0.0000847, and α is 1.0664; at 28 GHz, the rainfall coefficient K is 0.9679, and α is 0.2051; and at 40 GHz, the rainfall coefficient K is 0.8673, and α is 0.4431.
S3, modeling on a near-ground small-scale fading channel is performed, specifically including: multipath effect modeling; and
S301, the multipath effect modeling is as shown in FIG. 2, and a low Earth orbit satellite transmitter is assumed to always point to a ground terminal. When a transmitted signal propagates over a long distance in the atmosphere, signal energy is uniformly distributed on a cross-section perpendicular to a propagation direction, and the signal arrives above urban buildings. According to a plane wave assumption, an electromagnetic wave propagated by a low Earth orbit satellite through an ionosphere above an urban area approximates a circular plane with a radius Rₜ=5 m. A circle center lies on the line-of-sight path, and a distance from the circle center to a receiving antenna is fixed and set to 500 m. A normal vector v of the plane is a vector of the line-of-sight path. The plane uniformly emits a plurality of parallel rays of equal energy along the vector v.
S302, ray tracing-based multipath generation is performed. The ray tracing-based multipath generation specifically includes: when rays emitted from the circular equivalent planar array pass through a building surface, a corresponding reflection path is calculated by an image method, and at a receiving end, a sphere with a radius Rᵣ=1.5 m is used for reception determination. The emitted rays undergo single or multiple reflections, some of the rays reach the receiving end and are effectively received, and the rays that effectively reach the receiving end are calculated one by one to obtain a propagation path.
S4, a large-scale fading loss and multipath received power of a low Earth orbit satellite channel are calculated; and
S401, the large-scale fading is calculated as follows:

PL=PL_{fs}+PL_{fluc}+PLᵣₐᵢₙ
where PL_{fluc} represents an ionospheric scintillation loss, PLᵣₐᵢₙ is a rainfall loss, and PL_{fs} is a free-space path loss, with a calculation method as follows:

PL_{fs}=32.44+20 log₁₀L(km)+20 log₁₀f(MHz)
S402, the small-scale fading includes multipath received power that is calculated as follows:

$${P}_{mp} ( {τ}_{i} ) = {{P}_{t} [ \frac{λ}{4 π} ]}^{2} {\vert \frac{{r}_{i} {e}^{- j {Δϕ}_{i}}}{{l}_{i}} \vert}^{2}$$

where τᵢ is a time delay of an i^{th} reflected path relative to the line-of-sight path, lᵢ is a length of an i^{th} path, Pₜ represents transmit power, λ is a signal wavelength, rᵢ is a reflection coefficient, and Δφᵢ 2π(lᵢ−lᵢ)/λ is a phase difference of the i^{th} path relative to the line-of-sight path. When the line-of-sight path exists,

$${τ}_{i} = \frac{{l}_{i} - {l}_{1}}{c} .$$

Each signal reflection causes a loss of signal energy, and C third-order and higher-order reflected signal components are negligible because they are submerged in noise. Therefore, a multipath reflection model includes direct signals, first-order reflected signals, and second-order reflected signals. In the second-order reflected signals, rᵢ is a product of two reflection coefficients.

Root-mean-square (RMS) delay spread is calculated as follows:

$$σ = \sqrt{\overline{{τ}^{2}} - {\overline{τ}}^{2}}$$

where τ̅²̅ is a second-order moment of a power delay profile (PDP). The RMS delay spread reflects a degree of multipath delay dispersion.

Therefore, total multipath received power is calculated as follows:

$${P}_{mp} = 10 {log}_{10} [ {{P}_{t} ( \frac{λ}{4 π} )}^{2} {\vert \frac{1}{{l}_{1}} + {\sum }_{i = 2}^{N} \frac{{r}_{i} {e}^{- j {Δϕ}_{i}}}{{l}_{i}} \vert}^{2} ]$$

S5, power delay profiles for different scenarios, multipath received power at different satellite elevation angles, and received power at different rainfall rates are calculated. A multipath power delay profile is derived from the multipath received power according to a multipath dataset.

In combination with the ionospheric scintillation loss and the rainfall loss, total received power is calculated as follows:

$${P}_{r} = \{ \begin{matrix}{P}_{mp} - {PL}_{fs} - {PL}_{fluc} , f \leq 3 GHz \\ {P}_{mp} - {PL}_{fs} - {PL}_{rain} , f > 3 GHz\end{matrix}$$

The total received power under different influencing factors can be obtained by changing the satellite elevation angle θ, the rainfall rate R_{0.01}, and the operating frequency.

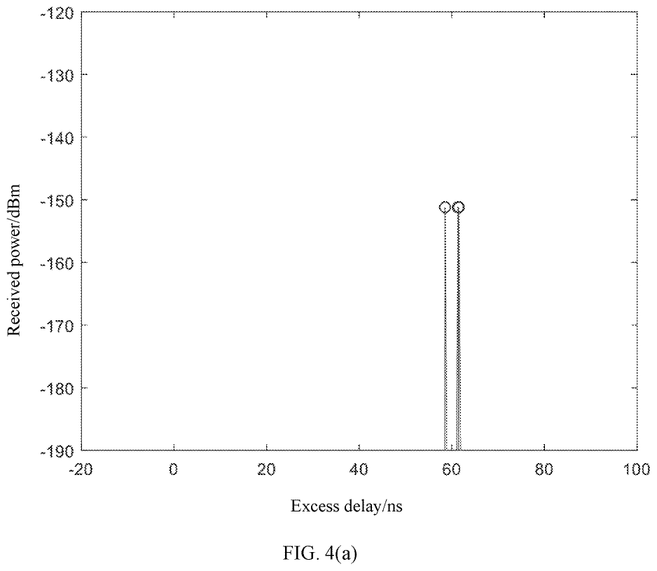

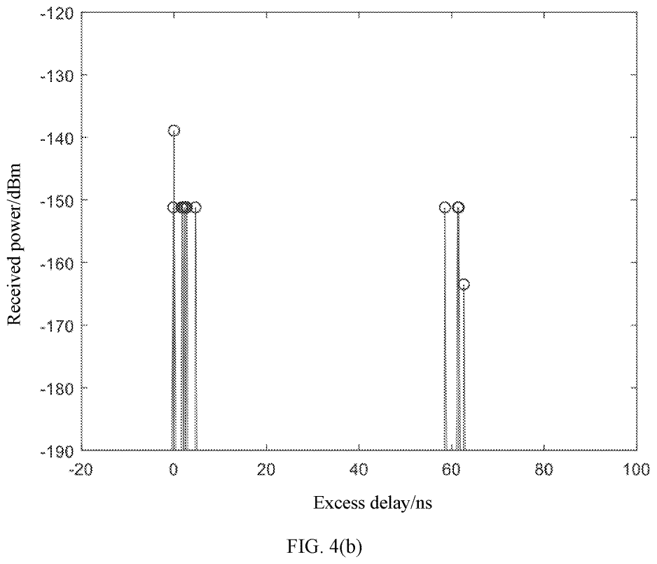

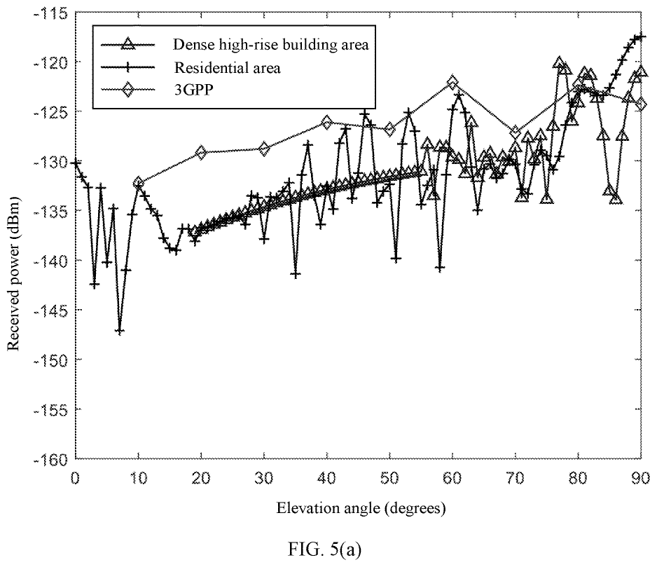

FIGS. 4(a) and 4(b) show that in a dense high-rise building environment, the receiving antenna receives 3 first-order reflected paths, the line-of-sight path is blocked by tall buildings, the RMS delay spread is 1.36 ns, and the total received power is −148.8 dBm; and in a residential area environment, the receiving antenna receives 12 paths, including 1 line-of-sight path, 10 first-order reflected paths, and 1 second-order reflected path, the RMS delay spread is 28.02 ns, and the total received power is −135.5 dBm. Simulation results show that the line-of-sight path may be blocked in a dense high-rise building area when the satellite elevation angle is small, and the total received power is significantly reduced in this case, therefore, line-of-sight path blocking should be prevented as much as possible at a position of antenna deployment. In a residential area, rare building blockage and a low height of the receiving antenna result in relatively short reflection delay from roofs, and relatively long reflection delay from building sides, as well as presence of second-order reflected paths; and in this case, the RMS delay spread is greatly affected by reflected paths, and the total received power is higher.

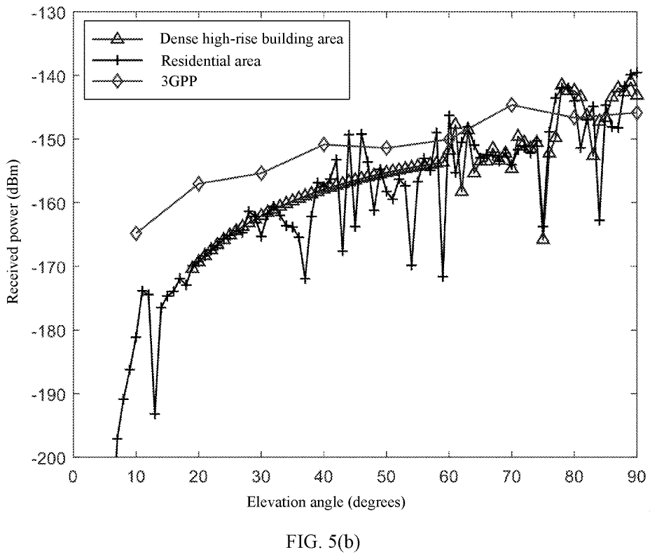

FIGS. 5(a) and 5(b) show that in part of a dense high-rise building area where the satellite elevation angle is approximately 0-20°, no received power exists due to building blockage. Since only the line-of-sight path exists without reflected paths at the satellite elevation angle of approximately 0-50°, the total received power rises steadily. When the satellite elevation angle exceeds 50°, multipath effects are generated by reflected paths from the roofs, resulting in that the total received power fluctuates significantly with an increasing elevation angle, generally showing an upward trend. The above simulation results are compared with a model standard for satellite-to-ground received power in dense urban areas specified in 3GPP TR 38.811, and it can be seen that the model of the present disclosure exhibits a basically consistent trend with the 3GPP model standard. Slight differences exist between simulated received power and a standard calculated value due to inconsistencies with parameters in the standard. Differences exist between received power and the standard value at high frequency bands, because in an L band (2 GHz), the total received power is only affected by ionospheric scintillation, and the ionospheric scintillation fade is approximately 6 dB; and in a Ka band (28 GHz), the ionospheric scintillation fade is almost negligible for the total received power, but the rain fade effect is prominent, the rain fade is approximately 16 dB at an elevation angle of 20°, and the rain fade is approximately 5.7 dB at an elevation angle of 75°. Simulation result comparison between the dense high-rise building area and the residential area reveals that the received power fluctuates more significantly in the residential area due to more reflected paths and stronger multipath effects in the residential area.

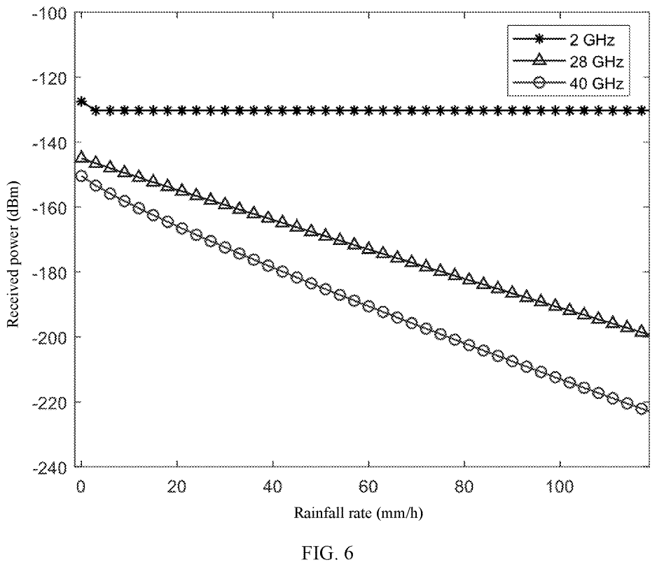

FIG. 6 illustrates the correlation of received power at different rainfall rates with a rainfall rate and an operating frequency. At 2 GHz, the received power is almost unaffected by rain attenuation, while at 40 GHz, the received power attenuates significantly. Simulation results show that at a higher frequency, the received power is lower, and rain attenuation has a greater impact on a millimeter-wave frequency band of a low Earth orbit satellite communication system. To solve the rain attenuation problem, an antenna with a narrow beamwidth may be used to reduce attenuation caused by rain absorption.

In summary, the present disclosure provides the ray tracing-based channel modeling method directed to low Earth orbit satellite communication, takes into consideration the influences of ionospheric scintillation and rainfall in the atmosphere, and models near-ground multipath effects using a circular equivalent planar array for transmitting. The method features higher accuracy, moderate complexity, and better universality, and enriches low Earth orbit satellite channel modeling methods, and simulated statistical characteristics have reference value for the design of low Earth orbit satellite communication systems.

Anything not described in detail in the present disclosure is a technology well known to those skilled in the art.

As above, although the present disclosure has been shown and described with reference to specific preferred embodiments, this should not be construed as limiting the present disclosure. Various changes in forms and details can be made therein without departing from the spirit and scope of the present disclosure as defined by the appended claims.

What is claimed is:

1. A computer-implemented ray tracing-based channel modeling method directed to low Earth orbit satellite communication, the method being performed by one or more processors and comprising the following steps:
S1, generating low Earth orbit satellite system parameters, wherein the low Earth orbit satellite system parameters comprise basic parameters, atmospheric channel environment parameters, and near-ground channel environment parameters;
S2, performing modeling on a large-scale fading channel, comprising ionospheric scintillation fading modeling and rain attenuation modeling;
S3, performing modeling on a near-ground small-scale fading channel, comprising ray tracing-based multipath effect modeling;
S4, calculating a large-scale fading loss and multipath received power of a low Earth orbit satellite channel on the basis of steps S1 to S3;
S5, calculating total received power and a power delay profile according to the large-scale fading loss and the multipath received power calculated in the step S4; and
S6, outputting the total received power and the power delay profile of the low Earth orbit satellite channel for analyzing channel characteristics, determining an antenna deployment position that avoids line-of-sight path blocking, evaluating an antenna beamwidth for reducing rain attenuation, or performing simulation of a low Earth orbit satellite communication system.

2. The ray tracing-based channel modeling method directed to low Earth orbit satellite communication according to claim 1, wherein the basic parameters in the step S1 comprise a satellite altitude, an elevation angle, an operating frequency band, and transmit power; and
a satellite-to-near-ground communication link distance L is calculated according to the basic parameters:
$$L = \sqrt{{R}_{E}^{2} {sin}^{2} θ + {H}^{2} + 2 {R}_{E} H} - {R}_{E} sin θ ;$$
in the formula, θ is a satellite elevation angle, H is a satellite altitude, and R_{E} is an Earth radius.

3. The ray tracing-based channel modeling method directed to low Earth orbit satellite communication according to claim 1, wherein the atmospheric channel environment parameters in the step S1 comprise an ionospheric scintillation parameter and a rainfall parameter;
the ionospheric scintillation parameter S is configured to describe an intensity of ionospheric scintillation and is calculated as follows:
$$S = {( \frac{〈 {I}^{2} 〉 - {〈 I 〉}^{2}}{{〈 I 〉}^{2}} )}^{\frac{1}{2}} ;$$
in the formula, I represents a signal intensity proportional to a square root of a signal amplitude;
<*> denotes an ensemble average of values in parentheses; and
the ionospheric scintillation parameter S satisfies the following relationship with an operating frequency:
S=fⁿ;
in the formula, f is an operating frequency, and n is a scintillation index factor; and
the rainfall parameter comprises a rainfall rate; and the rainfall rate is a rainfall rate at a predetermined system outage probability.

4. The ray tracing-based channel modeling method directed to low Earth orbit satellite communication according to claim 1, wherein the near-ground channel environment parameters in the step S1 are urban building scenario parameters; the urban building scenario parameters comprise a building outline dimension, a building height, and a building surface reflection coefficient;
the building outline dimension comprises building edge point coordinates and a building spacing;
the building height h follows a Rayleigh distribution P(h) of a parameter γ:
$$P ( h ) = \frac{{e}^{- \frac{{h}^{2}}{2 {γ}^{2}}} h}{{γ}^{2}} ;$$
in the formula, the parameter γ is a typical building height in an urban scenario; and
the building surface reflection coefficient r is expressed as follows:
$$r = \frac{{ε}_{r} sin α - \sqrt{{ε}_{r} - {cos}^{2} α}}{{ε}_{r} sin α + \sqrt{{ε}_{r} - {cos}^{2} α}} ;$$
in the formula, εᵣ represents a dielectric constant of a building surface material; and a denotes an included angle between an incident wave and a dielectric surface.

5. The ray tracing-based channel modeling method directed to low Earth orbit satellite communication according to claim 3, wherein the ionospheric scintillation fading modeling in the step S2 comprises calculating an ionospheric scintillation loss according to a scintillation index:
PL_{fluc}=27.5×S^{1.26}
in the formula, PL_{fluc} represents an ionospheric scintillation loss in dB; and S represents the ionospheric scintillation parameter.

6. The ray tracing-based channel modeling method directed to low Earth orbit satellite communication according to claim 2, wherein the rain attenuation modeling in the step S2 comprises:
determining an equivalent path length L(R_{0.01}, θ) based on a rainfall intensity R_{0.01} and the satellite elevation angle θ:
$$L ( {R}_{0.01} , θ ) = {[ 7.41 \times {10}^{- 3} {R}_{0.01}^{0.776} + ( 0.232 - 1.8 \times {10}^{- 4} {R}_{0.01} ) sin θ ]}^{- 1} ;$$
calculating a rain-induced fade PLᵣₐᵢₙ:
PLᵣₐᵢₙ=K(R_{0.01})^{α}L(R_{0.01},θ);
in the formula, parameters K and α are rain attenuation coefficients related to the operating frequency f, the satellite elevation angle θ, and a polarization tilt angle.

7. The ray tracing-based channel modeling method directed to low Earth orbit satellite communication according to claim 1, wherein the ray tracing-based multipath effect modeling in the step S3 comprises:
S301, generating a near-ground circular equivalent planar array for transmitting;
a low Earth orbit satellite transmitter is assumed to always point to a ground terminal; when a transmitted signal propagates over a long distance in the atmosphere, signal energy is uniformly distributed on a cross-section perpendicular to a propagation direction, and the signal arrives above urban buildings;
according to a plane wave assumption, an electromagnetic wave propagated by a low Earth orbit satellite through an ionosphere above an urban area approximates a circular plane with a radius Rₜ, and the radius Rₜ depends on a satellite altitude;
a center of the circular plane lies on a line-of-sight path, and a distance from the center to a receiving antenna is fixed; a normal vector v of the circular plane is a vector of the line-of-sight path; the circular plane uniformly emits a plurality of parallel rays of equal energy along the vector v;
S302, performing ray tracing-based multipath generation;
when rays emitted from the circular equivalent planar array pass through a building surface, a corresponding reflection path is calculated by an image method, and at a receiving end, a sphere with a radius Rᵣ is used for reception determination; and
the emitted rays undergo single or multiple reflections, some of the rays reach the receiving end and are effectively received, and the rays that effectively reach the receiving end are calculated one by one to obtain a propagation path.

8. The ray tracing-based channel modeling method directed to low Earth orbit satellite communication according to claim 2, wherein the large-scale fading loss PL of a low Earth orbit satellite channel is calculated as follows:
$$PL = \{ \begin{matrix}{PL}_{fs} + {PL}_{fluc} , f \leq 3 GHz \\ {PL}_{fs} + {PL}_{rain} , f > 3 GHz\end{matrix} ;$$
in the formula, PL_{fluc} represents an ionospheric scintillation loss, PLᵣₐᵢₙ is a rainfall loss, and PL_{fs} is a free-space path loss; and
the free-space path loss PL_{fs} is calculated as follows:
PL_{fs}=32.44+20 log₁₀L(km)+20 log₁₀f(MHz);
in the formula, L (km) represents the satellite-to-near-ground communication link distance;
and f (MHz) represents the operating frequency.

9. The ray tracing-based channel modeling method directed to low Earth orbit satellite communication according to claim 8, wherein the multipath received power Pₘₚ(τᵢ) is calculated as follows:
$${P}_{mp} ( {τ}_{i} ) = {{P}_{t} [ \frac{λ}{4 π} ]}^{2} {\vert \frac{{r}_{i} {e}^{- j {Δϕ}_{i}}}{{l}_{i}} \vert}^{2} {}^{2} ;$$
in the formula, τᵢ is a time delay of an i^{th} reflected path relative to the line-of-sight path, lᵢ is a length of an i^{th} path, Pₜ represents transmit power, λ is a signal wavelength, rᵢ is a reflection coefficient, and Δφᵢ=2π(lᵢ−lᵢ)/λ is a phase difference of the i^{th} path relative to the line-of-sight path.

10. The ray tracing-based channel modeling method directed to low Earth orbit satellite communication according to claim 9, wherein the total received power Pᵣ in the step S5 is calculated as follows:
$${P}_{r} = \{ \begin{matrix}{P}_{mp} - {PL}_{fs} - {PL}_{fluc} , f \leq 3 GHz \\ {P}_{mp} - {PL}_{fs} - {PL}_{rain} , f > 3 GHz\end{matrix}$$
in the formula, PL_{fs} represents the free-space path loss; PL_{fluc} represents the ionospheric scintillation loss; PLᵣₐᵢₙ represents the rainfall loss; Pₘₚ represents total multipath received power;
the multipath received power Pₘₚ is calculated as follows:
$${P}_{mp} = 10 {log}_{10} [ {{P}_{t} ( \frac{λ}{4 π} )}^{2} {\vert \frac{1}{{l}_{1}} + {\sum }_{i = 2}^{N} \frac{{r}_{i} {e}^{- j {Δϕ}_{i}}}{{l}_{i}} \vert}^{2} ] ;$$
in the formula, lᵢ is the length of an i^{th} path, Pₜ represents transmit power, λ is the signal wavelength, rᵢ is the reflection coefficient, and Δφᵢ=2π(lᵢ−lᵢ)/λ is the phase difference of the i^{th} path relative to the line-of-sight path; and
the power delay profile Pᵣ(Ti) is calculated as follows:
$${P}_{r} ( {τ}_{i} ) = \{ \begin{matrix}{P}_{mp} ( {τ}_{i} ) - {PL}_{fs} - {PL}_{fluc} , f \leq 3 GHz \\ {P}_{mp ( {τ}_{i} )} - {PL}_{fs} - {PL}_{rain} , f > 3 GHz\end{matrix}$$
in the formula, Pₘₚ(τᵢ) represents the multipath received power; PL_{fs} represents the free-space path loss; PL_{fluc} represents the ionospheric scintillation loss; PLᵣₐᵢₙ represents the rainfall loss;
and f represents the operating frequency.
